(19) United States
(12) Patent Application Publication
(10) Pub. No.: US 2004/0139036 A1
(43) Pub. Date: Jul. 15, 2004

(54) Method and system for scheduling supply driven processing such as mail sorting

(75) Inventors: Thomas G. Acton, Berkshire, NY (US); Michael L. Aigen, Vestal, NY (US); Patrick R. Fry, Vestal, NY (US); Cynthia C. Munger, Endwell, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation

(21) Appl. No.: 10/340,297

(22) Filed: Jan. 10, 2003

(51) Int. Cl. G06F 17/60

(52) U.S. Cl. 705/401; 705/404; 705/9

(57) ABSTRACT

A system or method for scheduling supply driven processes such as the processing of mail includes projecting arrival data for mail articles during a processing period, determining a processing schedule of available equipment and personnel for processing mail articles during the processing period, simulating the processing of mail articles during the processing schedule determined for the arrival data to evaluate processing performance, and determining any changes for the processing schedule based upon simulating the processing. A method for scheduling a multi-operation process to handle arriving raw material of uncontrolled amounts and types, in accordance with performance objectives, includes similar steps.

### FIELD OF THE INVENTION

The present invention generally relates to complex process planning, and in particular to the planning of supply driven processing such as mail sorting.

### BACKGROUND OF THE INVENTION

One example of an extremely complex, supply-driven process is the processing of mail articles by the U.S. Postal Service. This complexity derives from the wide variety of different types of mail and the different ways they are handled. This complexity is further exacerbated by the tremendous volume of mail and further by the significant day to day variability of both the volume of mail articles received and their respective types.

Software based process planners have been used for some time for a wide variety of industrial and quasi-governmental operations. Existing process planners are typically “orders driven,” in that orders for manufactured goods are received and the manufacturing process involves obtaining the necessary raw materials or parts and successfully processing and/or assembling such to finished product. In distinction, some processes are “supply driven,” such as the processing of mail articles, wherein the objective is to process all mail received and deliver it within service compliance criteria according to type.

Due to the tremendous volume of mail generated in a free-economy society and the resulting demand for effectiveness and efficiency in the U.S. Postal Service, significant reliance is placed on automation and the performance provided by such equipment. To further enhance efficiency, various types of equipment are designed to function in more than one specific role in the mail sorting process. This reduces the time during which the equipment is idle, thus improving its return on investment. Of course, this multi-use equipment complicates the scheduling of mail processing, as does the need for both equipment maintenance and skilled operators to run the equipment.

### SUMMARY OF THE INVENTION

A system or method for scheduling the processing of mail generally includes projecting arrival data for mail articles during a processing period, determining a processing schedule of available equipment and personnel for processing mail articles during the processing period, simulating the processing of mail articles using the processing schedule determined for the arrival data projected to evaluate processing performance, and determining any changes for the processing schedule based upon the step of simulating the processing.

Enhancements may include repeating the step of simulating the processing schedule with any changes to the schedule to evaluate processing performance, and further repeating the steps of determining any changes to the processing schedule and simulating the changed processing schedule as necessary to define an acceptable processing schedule. This same system or method may include collecting current arrival data of actually received mail articles during at least a portion of the processing period and repeating the step of simulating the processing schedule based upon the current arrival data.

In another enhancement, the step of projecting arrival data may include using historical data and considering any additional data of current conditions, such as advanced notice of mail articles scheduled to arrive during the processing period and any amounts of incompletely processed mail articles left over from a prior processing period.

Yet another enhancement involves the processing schedule including a multiplicity of scheduled operations, and the step of simulating including calculating the performance of each scheduled operation over the processing period. Further, the step of calculating may include dividing the processing period into sequential time segments and sequentially calculating the performance of each scheduled operation for each sequential time segment. This step of sequentially calculating may include first calculating an input mail count for use by a respective operation during a respective time segment, secondly calculating an output mail count based upon the input mail count and a known throughput for the operation, and thirdly calculating an unprocessed mail count for use in the step of sequentially calculating for a subsequent time segment.

In an alternate embodiment, a method for scheduling a multi-operation process to handle arriving raw material of uncontrolled amounts and types, in accordance with performance objectives, includes projecting arrival data for raw material during a processing period, determining a processing schedule of available resources for processing raw material during the processing period with the multi-operation process, simulating processing of raw material using the processing schedule determined for the arrival data projected, to evaluate processing performance against performance objectives, and determining any changes for the processing schedule based upon the step of simulating processing. This embodiment may be enhanced in a similar manner to the above-described embodiment.

### BRIEF DESCRIPTION OF THE DRAWINGS

The present invention is illustratively shown and described in reference to the appended drawings in which:

FIG. 1 is a flow diagram of a nominal mail sorting process;

FIG. 2 is a table detailing the process steps of the diagram of FIG. 1;

FIG. 3 is a flow diagram of the details of FIG. 2;

FIG. 4 is a table of mail arrivals which might be encountered by the process of FIG. 1;

FIG. 5 is a flow chart of a system and process constructed accordance with one embodiment of the present invention; and

FIG. 6 is a flow chart of a portion of the system of FIG. 5.

### DETAILED DESCRIPTION OF THE DRAWINGS

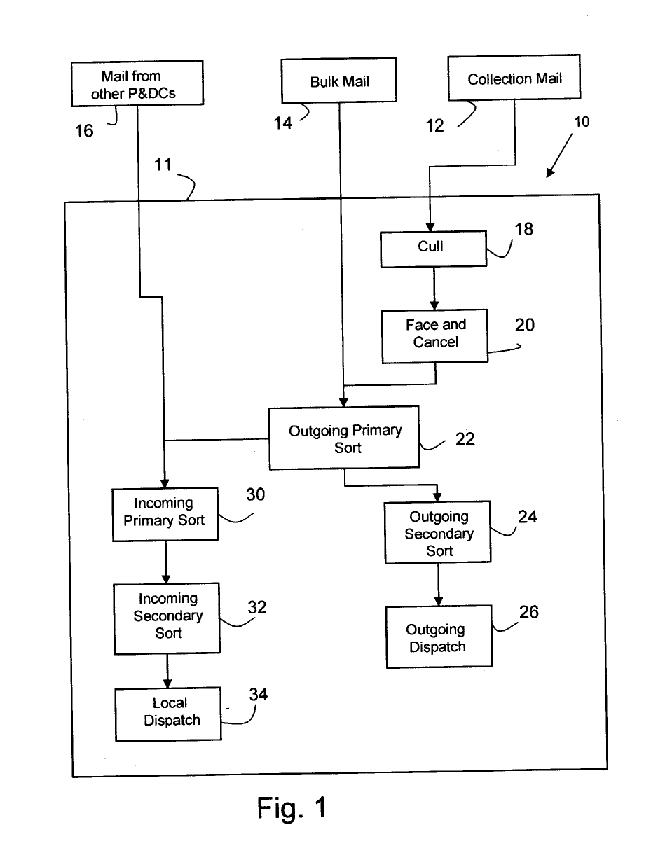

The complexity of mail processing is described in reference to FIGS. 1-4, in which FIG. 1 is a block diagram of a nominal mail processing scheme 10 that might be used in a mail processing and distribution center (P&DC) 11 for handling just First Class and Bulk mail. Processing scheme 10 is offered herein as a demonstration of the significant complexity involved in mail processing and is not intended to be descriptive of a complete process.

Processing and distribution center (P&DC) 11 typically receives collection mail 12, bulk mail 14 from bulk mailers and local delivery mail 16 from other processing and distribution centers. Collection mail 12 may come from drop boxes and over-the-counter, and it may be completely random in nature. For this reason, it first goes through a Cull process 18 and a Face and Cancel process 20. This mail is then passed through an Outgoing Primary Sort function 22, along with all received bulk mail 14. The mail is distinguished within the processing scheme 10 as to whether it is Incoming, meaning addressed for delivery from this P&DC 11, or Outgoing, meaning that it must first be transported to another distribution center prior to delivery. Thus, the Outgoing Primary Sort function 22 is used to sort collection mail 12, and bulk mail 14 between the present P&DC 11 and all other distribution centers.

Outgoing mail is next sent through an Outgoing Secondary Sort 24 where it might be sorted for delivery to different specific processing and distribution centers. Lastly, Outgoing mail is sent to Outgoing Dispatch 26 where it is properly packaged and shipped. The shipping of Outgoing mail between mail processing and distribution centers is typically fixed by schedule, and part of the service compliance criteria is meeting those shipping schedules for newly received Outgoing mail.

Incoming mail which has been identified and separated from collection mail 12, along with local delivery mail 16 from other processing and distribution centers, is all passed through an Incoming Primary Sort process 30. Incoming mail then goes through an Incoming Secondary Sort step 32 before it is delivered to the Local Dispatch function 34.

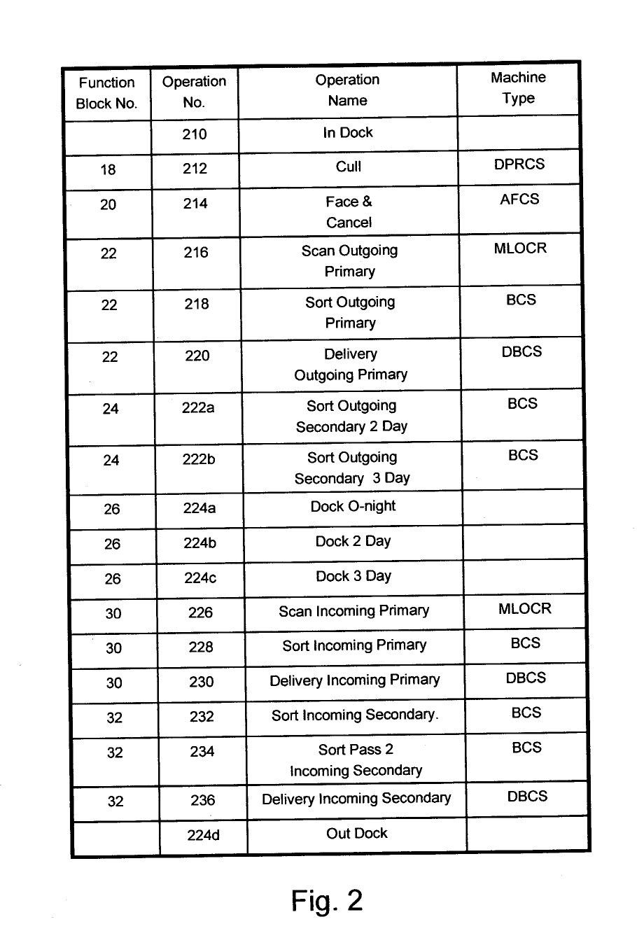

Processing scheme 10 is defined further in FIG. 2 which shows a table wherein the function blocks of FIG. 1 are broken down into their more specific processing operations. In FIG. 2, the function block numbers of FIG. 1 appear in the left hand, or first column. The second and third columns break each of the numbered function blocks down into one or more separate operations, which are identified in the second column by a number and in the third column by a name. The fourth column specifies the type of machinery needed to perform the specific function. The machine types are identified by initials which including DPRCS for Dual Pass Rough Cull System, AFCS for Advanced Face and Cancel System, MLOCR for Multi-Line Optical Character Reader, BCS for Bar Code Sorter, and DBCS for Delivery Bar Code Scanner.

It can be readily appreciated from the table of FIG. 2, that different types of machines are needed at more than one step in the overall processing scheme 10. For example, the Multi-Line Optical Character Reader, MLOCR, is needed for both the Outgoing Primary Sort function 22 and the Incoming Primary Sort function 30. Even more critically, the Bar Code Sorters, BCS, are needed in each of the Outgoing Primary Sort 22, Outgoing Secondary Sort 24, Incoming Primary Sort 30, and Incoming Secondary Sort 32. The Delivery Bar Code Sorters, DBCS, are likewise needed in three of those same four functions. For this reason, a P&DC typically has multiple units of each type of machine, which multiple units can be scheduled as needed to meet varying volumetric demands throughout the process. The complexity of scheduling the use of this equipment is only increased by the availability of trained operators and their work schedules.

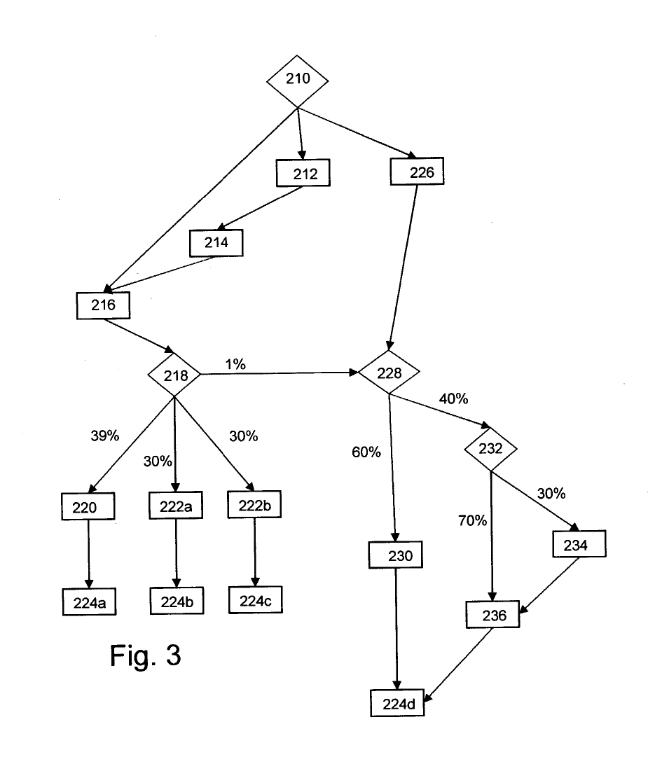

The complexity of the nominal process described in FIGS. 1 and 2 is further shown in FIG. 3, which is a flow chart of the specific operations listed in FIG. 2. FIG. 3 shows the convolutions of various operations, such as how the entire output of a sorting operation may be split between two separate, subsequent operations. For example, the output of Sort Outgoing Primary 218 is split between four subsequent sorting operations 220, 222a, 222b, and 228. Also, certain operations may receive mail for processing from different previous operations. For example, the Sort Incoming Primary operation 228 receives mail from both the sorting operation 218 as well as the Scan Incoming Primary operation 226.

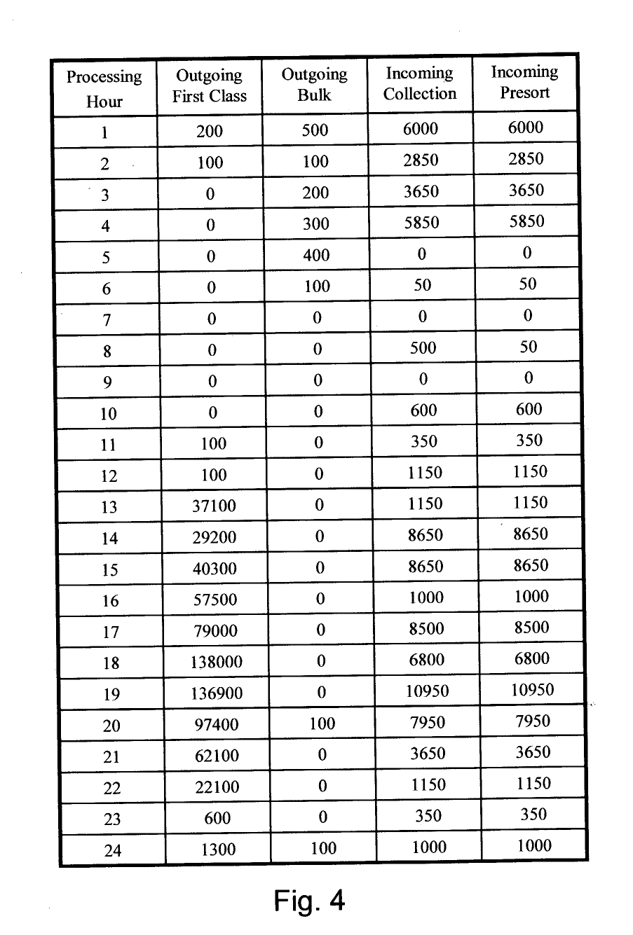

The sorting process described in FIGS. 1, 2 and 3 and the scheduling of specific equipment for various steps therein is further complicated by the rate at which mail articles enter the processing scheme 10. FIG. 4 shows an example of one possible arrival schedule for mail articles to the processing and distribution center 11. While one possible arrival schedule is shown, an infinite variety of arrival schedules are readily produced in possible correlation with the day of the month, the day of the week, and the week of the year. Although the schedules of drop-box collections may be controlled, the schedules and actions of large volume mailers cannot be significantly controlled.

As a result of varying arrival schedules as exemplified in FIG. 4, it is important that mail articles be allowed to substantially continuously flow through the process exemplified in FIGS. 1, 2 and 3. Yet because of the significant and variable volumes involved, it is also necessary to contemporaneously re-assign multi-use equipment to certain portions of the process in accordance with volumetric demand. It is the challenge of meeting these volumetric variations, and performing the necessary processes to meet the delivery compliance objectives for different classes of mail, to which the invention of the present application is addressed. It should also be kept in mind that the present invention is not limited to mail processing and is also applicable to the scheduling of other supply-driven, multi-operation processes which handle arriving raw material of uncontrolled amounts and types and must process that raw material in accordance with performance objectives.

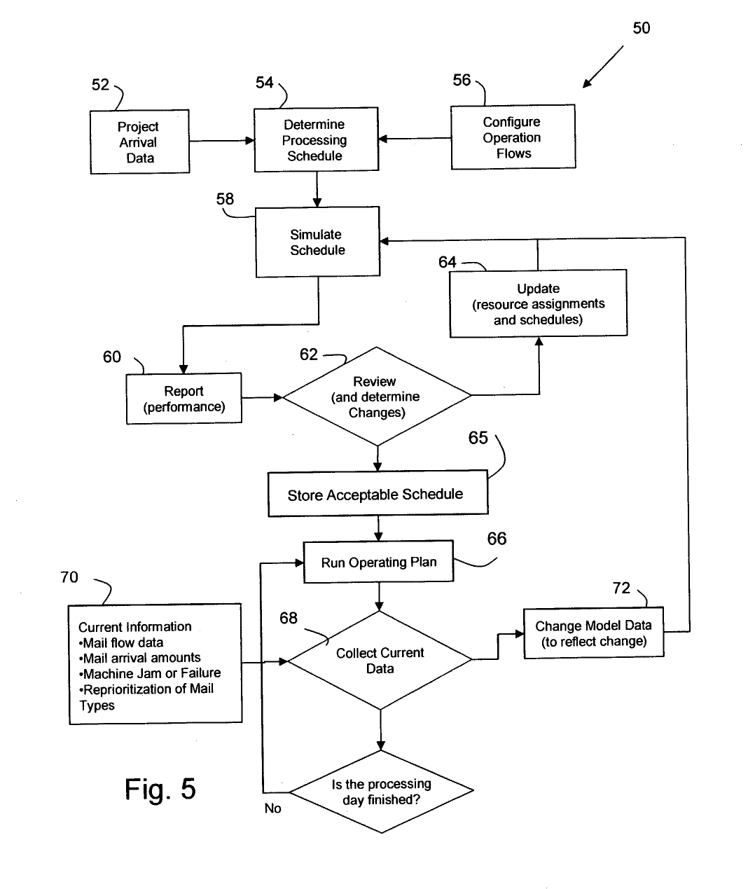

One embodiment of the present invention is now described in reference to FIG. 5, which shows a flow chart of a method and System 50 for processing mail articles in a P&DC. System 50 would be used to schedule processing for each respective processing period, which might be set to coincide with the above-mentioned shipping time of Outgoing mail to other P&DCs, or to any other criteria that has a significant impact on scheduling, such as work shifts. The shipping of Outgoing mail to other P&DCs varies widely between locations, depending upon volume and predominant mail patterns. Where most of the shipping times repeat on a daily basis, the processing period may typically be set to twenty-four hours in length.

An initial process of System 50 is to Project Arrival Data 52 of the mail articles expected to arrive during a processing period. Such data would typically include amounts, types and arrival schedules for all mail to be received at a given mail processing location or facility as exemplified in FIG. 4. Such projections of arrival data would typically be based upon any known historical data as well as any additional data of current conditions. Current conditions may include advanced arrival data reports from other mail processing facilities, as well as any incompletely processed mail articles left over from the prior day or processing period. The historical data may be collected on any basis that would provide a known consistency, such as day of the month, day of the week or the week of the year. Such data might also include a statistical variation to account for minimum and maximum ranges. The recalling of such historic data may be performed automatically by software.

System 50 further includes a process to Determine Processing Schedule 54 of available resources, such as equipment and personnel, for processing mail articles in the proper manner during the processing period. The manner of processing depends upon the required steps and operations as exemplified in FIGS. 1-3 and thus accounts for machine types, numbers and processing capacity, as well as personnel numbers and skills to produce individual machine and personnel schedules to fulfill the required operations as exemplified in FIGS. 2 and 3. Any known variations in available personnel and equipment, such as those due to personnel absences and equipment maintenance are considered. Any such variations which arise subsequently are handled by another process of System 50.

An inherent part of determining a processing schedule would include a process to Configure Operation Flows 56 for the particular facility. This is normally performed initially for each processing and distribution center and subsequently updated with significant changes at the specific processing and distribution center.

Determine Processing Schedule 54 may include the original generation of a new schedule or the simple selection of an already existing schedule created in response to similar resource availability of personnel and equipment. Software may be used to receive resource data, and historic arrival data, to select a previously used schedule, which is known to be successful under similar conditions.

System 50 then analyzes the determined processing schedule with the projected arrival data in a process Simulate Schedule 58. Simulate Schedule 58 generally sequences through the determined schedule to calculate the flow of processing with the projected arrival schedule. From these calculations, Simulate Schedule 58 then produces a performance Report 60, including the determined schedule and service level compliance to performance objectives. The software of Simulate Schedule 58 can identify specific failures in the processing schedule and may be programmed to suggest various changes to the determined schedule.

Review 62 then allows for a review of the performance Report 60 and a determination of any changes which might be made to the processing schedule to either improve the service level commitment compliance or simply enhance processing efficiency. This determination of any changes which might be made to the schedule preferably includes an option for human input. In this manner, the changes determined for the processing schedule may be made with the same insight as the original schedule determination and thereby compensate for considerations which cannot be programmed. In the event that the software of Simulate Schedule 58 is used to suggest any changes in the performance Report 60, Review 62 could include human intervention to accept or reject any suggested changes. In the present context, the term “changes” is intended to encompass any variety of modifications, such as one or multiple, or even alternate changes which might be derived from either human input or automatically generated by Simulate Schedule 58. Examples of specific changes which might be made in a mail processing function include a redistribution of different units of a specific equipment type among concurrent operations or the reassignment of qualified personnel between concurrent operations.

Once any changes are determined, the processing schedule is updated accordingly in Update 64 and the process is returned to Simulate Schedule 58 for the purpose of evaluating processing performance. Such processes of Simulate Schedule 58, Report 60, Review 62 and Update 64 may be repeated as necessary for the purpose of ultimately defining an acceptable processing schedule. Once an acceptable processing schedule is defined, it is saved in Store Acceptable Schedule 65.

The portions of System 50 which have be described up to Store Acceptable Schedule 65, are typically performed in advance of a respective processing period. The value of such advanced planning will depend upon the reliability of the arrival and resource data used. Work schedules for personnel and equipment maintenance might be set up a week or more in advance and used as a basis for this advanced planning. The above-described steps may also be performed in closer proximity to the start of a processing period using the most current information. When an actual operating period is close at hand, the stored schedule may be recalled and loaded for real-time use.

System 50 begins at Run Stored Schedule 66 for real time control of processing using the further process of Collect Current Data 68 concerning available personnel and equipment and the projected and actual arrival data of mail articles during the processing period. This information is necessarily more contemporaneous to the operating period and may come from any convenient or available source 70. For example, actual arrival data may be collected at a receiving dock in the processing facility or it might be derived from processing equipment handling a previously unknown quantity of mail. Similarly, breakdowns or jams in equipment, which might have an effect on processing performance may be collected. Contemporaneous changes in personnel availability may be considered. Real-time, machine performance data may also be used as available. Such performance data might be automatically collected and made available to System 50.

Collecting Current Data 68 preferably includes a human component which might determine the significance of any reported changes prior to engaging System 50 to compensate. Thus, various information, such as the aforesaid performance data, might be monitored just for problems and not otherwise used until the need for a re-simulation is otherwise determined. Changes determined to be significant would then be input in Change Model Data 72 and Simulate Schedule 58 would be re-initiated in response thereto. Once again an acceptable processing schedule would be determined for the remainder of the operating period and such schedule would be saved at Store Acceptable Schedule 65.

In the event that Collecting Current Data 68 receives no further data it simply waits until the processing period is completed. As mentioned, the acceptable processing schedule has been stored so that it might be available for future use in Determine Processing Schedule 54. The schedules stored may be indexed to identify each schedule in terms of mail amounts, types and arrival schedules as well as in terms of equipment and personnel availability. In this manner, once an installed System 50 has gained sufficient experience at a given P&DC, the process of Determine Processing Schedule 54, based upon inputs of projected mail arrivals and available equipment and personnel, may be streamlined. However, given the infinite variability of these input conditions, the ability to make fine adjustments as well as real-time performance adjustments will still be desirable.

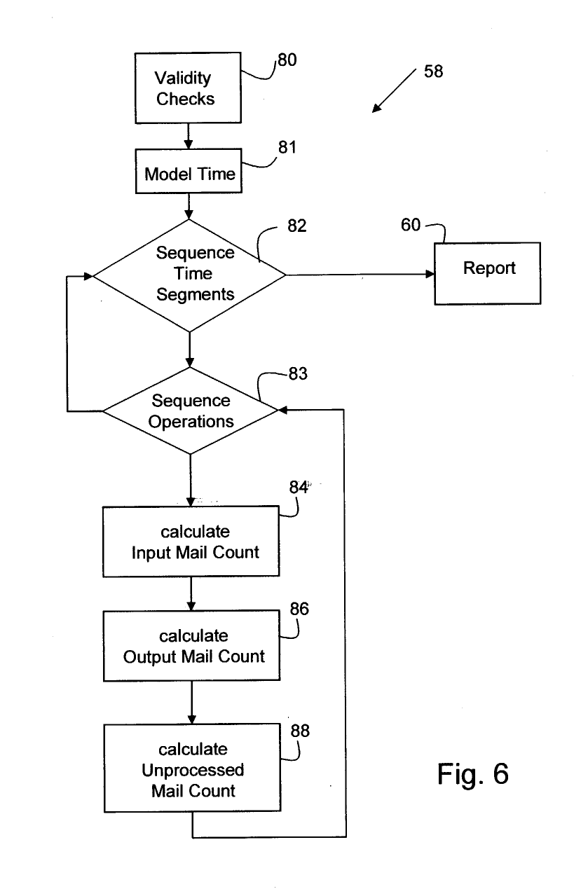

FIG. 6 is an algorithm flow chart of the Simulate Schedule 58 of FIG. 5. First, Validity Checks 80 are performed to ensure the consistency of the input data. This includes verifying that all resources have been assigned to operations they can perform, that no resource is used simultaneously at multiple operations, that all operations are performed, and that no circular flow patterns exist among the operations. Once these validity checks have been passed, Simulate Schedule 58 proceeds to calculate the performance of each scheduled operation over the course of the processing period.

Simulate Schedule 58 first sets Model Time 81. For the purpose of these calculations, the entire processing period is divided into sequential time segments, which are used by for calculating the performance of each scheduled operation for each sequential time segment. If the processing schedule is not yet in operation, Model Time 81 is set to zero, and if the processing schedule is in operation, Model Time 81 is set to the actual time segment of the processing schedule. Sequence Time Segments 82 then sequences through each of the time segments of a processing period, and Sequence Operations 83 sequences through each operation scheduled for each respective time segment. The specific calculations performed for each scheduled operation in each time segment include first calculating Input Mail Count 84, then calculating Output Mail Count 86, and finally calculating Unprocessed Mail Count 88.

Input Mail Count 84 is the mail available for current processing in an operation and includes mail processed from one or more previous sequential operations, or mail received at the P&DC 11 in the case of initially scheduled operations. Input Mail Count 84 also includes unprocessed mail remaining in an operation from the immediately preceding time segment.

Output Mail Count 86 is calculated in response to both Input Mail Count 84 and throughput rate of the respective operation. Output Mail Count 86 is inherently limited for each operation and time segment to the respective Input Mail Count 84. Output Mail Count 86 is stored for use in subsequent calculations of the performance of subsequently scheduled operations.

Unprocessed Mail Count 88 is the positive difference between Input Mail Count 84 and Output Mail Count 86 and is stored for use in the next time segment as part of the Input Mail count 84 for the same operation.

Sequencing through the calculations and time segments continues until the stop time of the entire operating plan is reached, at which point Report 60 is provided.

System 50 may further be enhanced by providing real time mail count data from the various operations, automatically generated by the equipment. Such data can be used as a source 70 for updating the processing schedule, or it can be used for more accurately simulating the remaining performance when the processing schedule is updated during operation. Such data may also be used to verify the accuracy of the calculated performance and thereby identify problems.

The present invention is illustratively described above in reference to the disclosed embodiments. Various modifications and changes may be made to the disclosed embodiments by persons skilled in the art without departing from the scope of the present invention as defined in the appended claims. As mentioned, the present invention may be used for the scheduling of other supply-driven complex processes wherein equipment and/or personnel assignments need to be managed for promptly servicing an unpredictable demand. One example might be a high volume, fast service dry cleaner.

What is claimed is:

1. A method for scheduling the processing of mail, comprising the steps of:
projecting arrival data for mail articles during a processing period;
determining a processing schedule of available equipment and personnel for processing mail articles during said processing period;
simulating the processing of mail articles using said processing schedule determined for said arrival data projected to evaluate processing performance; and
determining any changes for said processing schedule based upon said step of simulating the processing.

2. The method of claim 1, further comprising repeating the step of simulating said processing schedule determined with said any changes determined to evaluate processing performance.

3. The method of claim 2, further comprising repeating the steps of determining any changes and simulating said processing schedule as necessary to define an acceptable processing schedule.

4. The method of claim 3, further comprising collecting current arrival data of actually received mail articles during at least a portion of said processing period and repeating the step of simulating on said acceptable processing schedule based upon said current arrival data.

5. The method of claim 1, wherein said step of projecting arrival data includes using historical data and considering any additional data of current conditions, such as advanced notice of mail articles scheduled to arrive during said processing period and any amounts of incompletely processed mail articles left over from a prior processing period.

6. The method of claim 1, wherein said processing period for a mail processing location is a twenty-four hour period which ends just before scheduled departure times for mail articles being transported to other processing and distribution locations.

7. The method of claim 1, wherein said processing schedule includes a multiplicity of scheduled operations, and further wherein said step of simulating includes calculating the performance of each scheduled operation over said processing period.

8. The method of claim 7, wherein said step of calculating includes dividing said processing period into sequential time segments and sequentially calculating the performance of each scheduled operation for each sequential time segment.

9. The method of claim 8, wherein said step of sequentially calculating includes:
first calculating an input mail count for use by a respective operation during a respective time segment;
secondly calculating an output mail count based upon said input mail count and a known throughput for said respective operation; and
thirdly calculating an unprocessed mail count for use in said step of sequentially calculating for a subsequent time segment.

10. A system for scheduling the processing of mail, comprising:
a first process for projecting arrival data for mail articles during a processing period;
a second process for determining a processing schedule of available equipment and personnel for processing mail articles during said processing period;
a third process for simulating the processing of mail articles using said processing schedule determined for said arrival data projected to evaluate processing performance; and
a fourth process for determining any changes for said processing schedule based upon said step of simulating the processing.

11. The system of claim 10, further comprising a fifth process for collecting current arrival data on actually received mail articles during at least a portion of said processing period and repeating the third process of simulating said processing schedule based upon said current arrival data.

12. The system of claim 10, wherein said processing schedule includes a multiplicity of scheduled operations, and further wherein said third process for simulating includes a sixth process for calculating the performance of each scheduled operation over said processing period.

13. The system of claim 12, wherein said sixth process for calculating is adapted to divide said processing period into sequential time segments and includes a seventh process for sequentially calculating for each sequential time segment and each scheduled operation an input mail count for use by a respective operation during a respective time segment, an output mail count based upon said input mail count and a known throughput for said respective operation, and an unprocessed mail count for use in said sequentially calculating for a subsequent time segment.

14. A method for scheduling a multi-operation process to handle arriving raw material of uncontrolled amounts and types, in accordance with performance objectives, comprising the steps of:
projecting arrival data for raw material during a processing period;
determining a processing schedule of available resources for processing raw material during said processing period with said multi-operation process;
simulating processing of raw material using said processing schedule determined for said arrival data projected, to evaluate processing performance against performance objectives; and
determining any changes for said processing schedule based upon said step of simulating processing.

15. The method of claim 14, further comprising repeating the step of simulating said processing schedule determined with said any changes determined to evaluate processing performance.

16. The method of claim 15, further comprising repeating the steps of determining any changes and simulating said processing schedule as necessary to define an acceptable processing schedule.

17. The method of claim 16, further comprising collecting current arrival data on actually received raw material during at least a portion of said processing period and repeating the step of simulating on said acceptable processing schedule based upon said current arrival data.

18. The method of claim 14, wherein said step of projecting arrival data includes using historical data and considering any additional data of current conditions.

19. The method of claim 14, wherein said processing schedule includes a multiplicity of scheduled operations, and further wherein said step of simulating includes calculating the performance of each scheduled operation over said processing period.

20. The method of claim 14, wherein said step of calculating includes dividing said processing period into sequential time segments and sequentially calculating the performance for each sequential time segment of each scheduled operation.
